(19) United States
(12) Patent Application Publication
(10) Pub. No.: US 2026/0346829 A1
(43) Pub. Date: Nov. 5, 2026

(54) ELECTRONICALLY CONTROLLED PNEUMATIC PARKING BRAKE SYSTEM FOR A VEHICLE AND A METHOD FOR A CONTROLLER OF A VEHICLE

(71) Applicant: Scania CV AB, Södertälje (SE)

(72) Inventors: Sandeep GUPTA, Södertälje (SE); Xavier DREUX, Stockholm (SE)

(73) Assignee: Scania CV AB, Södertälje (SE)

(21) Appl. No.: 19/487,939

(22) PCT Filed: May 27, 2024
(86) PCT No.: PCT/SE2024/050519

§ 371 Date: Nov. 25, 2025

(30) Foreign Application Priority Data
Jun. 2, 2023 (SE) 2350681-9

(51) Int. Cl. B60T 17/22; B60T 13/68

(52) U.S. Cl. CPC B60T 17/221; B60T 13/683

(57) ABSTRACT

An electronically controlled pneumatic parking brake system for a vehicle is disclosed. It comprises a controller which generates signals to activate or release the parking brake based on received indications. The system also comprises an air supply source for compressed air, and two electropneumatic valves for engaging and releasing the parking brake, respectively. The controller is configured to generate and provide a flush control signal for opening the first electropneumatic valve and the second electropneumatic valve, thus allowing compressed air from the air supply source to flow through both valves, causing any moisture and/or particles accumulated in the valves to be evacuated to atmosphere via an exhaust port.

### CROSS-REFERENCE TO RELATED APPLICATIONS

This application is a national stage application (filed under 35 U.S.C. § 371) of PCT/SE 2024/050519, filed May 27, 2024, of the same title, which in turn claims priority to Swedish Patent App. No. 2350681-9, filed on Jun. 2, 2023; the contents of each of which are hereby incorporated herein by reference.

### TECHNICAL FIELD

This document concerns an electronically controlled pneumatic parking brake system for a vehicle according to the appended patent claims.

### BACKGROUND

In vehicles in general, a parking brake solution is often applied when the vehicle is parked in a standstill position, for avoiding that the vehicle starts rolling during unattended parking, which may cause severe accidents. The parking brake solution is important for any kind of vehicles, but perhaps in particular for heavier vehicles such as trucks, busses, and vehicle combinations, as consequences of an accident will be severe.

The vehicle, in case of a manned vehicle, often comprises a hand brake system which could be driver-activated by a parking brake control in the cabin of the vehicle. When activating the parking brake control, air is evacuated from a spring brake chamber/pneumatic brake circuit, and springs acting on the brakes of the vehicle exerts a load on the brakes and thereby preventing the wheels of the vehicle from rolling.

A problem with parking brakes in general is that they may freeze in sub-zero temperatures (Celsius), and thereby either be stuck in a released position, making it impossible to apply the parking brake; or alternatively be stuck in an applied position, making it impossible to release the parking brake.

In case the brakes become frozen in applied position after parking, the vehicle transportation will be delayed, and the vehicle may have to be towed to a garage or similar location for defrosting.

A known “solution” for preventing the parking brake to freeze in the applied position is to simply not apply the parking brake at all in cold/sub-zero temperatures. Although solving the problems concerning the parking brake frozen solid, other worries may emerge in case the vehicle starts rolling while being parked, for example due to impact of another vehicle and/or influence from gravity.

It appears that further improvement is required for improving parking safety and eliminate or at least reducing problems associated with frozen parking brakes of a vehicle in cold weather conditions.

### SUMMARY

It is therefore an object to solve at least some of the above problems and provide a safe parking brake solution for a vehicle also in cold temperature below zero degrees Celsius.

According to a first aspect of the invention, this objective is achieved by an electronically controlled pneumatic parking brake system for a vehicle. The system comprises a controller configured to generate an electronic brake apply signal when receiving an indication of that a parking brake is to be onset/activated. The controller is also configured to generate an electronic brake release signal when receiving an indication of that the parking brake is to be released/deactivated.

The system also comprises an air supply source, for providing compressed air. The system comprises a first electropneumatic valve, communicatively connected to the controller and connected to the air supply source and to a control chamber. The first electropneumatic valve is operable to release the parking brake by opening the valve, thereby allowing compressed air to flow through the first electropneumatic valve into the control chamber when receiving the electronic brake release signal from the controller.

The system in addition comprises a second electropneumatic valve, communicatively connected to the controller and connected to the control chamber and to an exhaust port. The electropneumatic valves may for example comprise solenoids, such as i.e., bistable solenoids, or any similar technical solution. The second electropneumatic valve is operable to activate the parking brake by opening the valve thereby releasing the compressed air from the control chamber to atmosphere via the second electropneumatic valve when receiving the electronic brake apply signal from the controller.

The controller is configured to generate and provide a flush control signal for simultaneously opening the first electropneumatic valve and the second electropneumatic valve. Compressed air from the air supply source is thereby allowed to flow through both the electropneumatic valves, causing any moisture and/or ice particles accumulated in the electropneumatic valves to be evacuated to atmosphere via the exhaust port.

Moisture accumulated in the system may eventually get converted into ice during cold weather conditions, below zero degrees Celsius. The moving parts in the valves are particularly sensitive for being frozen. In case they are frozen, the functionality of the parking brake is endangered as the change between states of the parking brakes (released/applied) is executed via the valves.

By intentionally flushing the valves, regularly, intermittently and/or strategically flushing the valves, blocked valves due to ice formation is prevented.

Preferably, the controller may be configured to generate and provide the flush control signal, when the vehicle is stationary.

By flushing the electropneumatic valves only when the vehicle is stationary, it is avoided that the brakes lock unintentionally during the flushing when the vehicle is driving.

Optionally, the controller may be configured to generate and provide the flush control signal when receiving an indication of that the parking brake is to be released/deactivated.

It is thereby assured that the electropneumatic valves are flushed regularly and automatically each time the parking brake is released. By flushing the valves when the parking brake is to be released, it is also implicitly assured that the vehicle is stationary and there is no risk of unintentional locking of the brakes during the flushing.

Optionally, the controller may be configured to, when receiving the indication of that the parking brake is to be released/deactivated, firstly generate and provide the flush control signal, and thereafter generate and provide the electronic brake release signal.

By firstly flushing the electropneumatic valves and then generate and provide the electronic brake release signal thereafter, consequences of unintentional locking of the brakes during the flushing are minimized or at least reduced.

Optionally, the controller may be configured to generate and provide the flush control signal when an environmental temperature is, or is predicted to be, lower than a temperature threshold limit.

When driving in hot climate, and/or in summertime, there is typically no risk of freezing. Flushing the electropneumatic valves is an advantage in cold climate/weather, but not necessarily when the temperature is, or is predicted to be reassuringly warmer than 0 degrees. By not performing the provided solution in temperatures wherein freezing of the valves could be safely excluded, time is saved at the moment of starting the vehicle after having been parked. Further, compressed air, and thus energy, is saved by not spending any compressed air on flushing the valves.

According to a second aspect of the invention, this objective is achieved by a method for a controller of a vehicle comprising an electronically controlled pneumatic parking brake system according to the first aspects. The method comprises the step of generating and providing a flush control signal for simultaneously opening the first electropneumatic valve and the second electropneumatic valve. Thereby, compressed air from the air supply source is allowed to flow through both electropneumatic valves, causing any moisture and/or ice particles accumulated in the electropneumatic valves to be evacuated to atmosphere via an exhaust port.

Moisture accumulated in the system may eventually get converted into ice during cold weather conditions, below zero degrees Celsius. The moving parts of the valves may then be rendered immobile by the ice, e.g., get stuck in a closed position. In case they are frozen, the functionality of the parking brake is endangered as the change between states of the parking brakes (released/applied) is executed via the valves.

By regularly, intermittently and/or strategically flushing the valves, blocked valves due to ice formation is prevented.

Optionally, the method also may comprise the step of determining that the vehicle is stationary. The flush control signal may be generated and provided when having determined that the vehicle is stationary.

By flushing the electropneumatic valves only when the vehicle is stationary, it is avoided that the brakes lock unintentionally during the flushing when the vehicle is driving.

Optionally, the method also may comprise the step of receiving an indication that the parking brake is to be released/deactivated. The flush control signal may be generated and provided when having received the indication that the parking brake is to be released/ deactivated.

It is thereby assured that the electropneumatic valves are flushed regularly and automatically each time the parking brake is released. By flushing the valves when the parking brake is to be released, it is also implicitly assured that the vehicle is stationary and there is no risk of unintentional locking of the brakes during the flushing.

Optionally, the step of generating and providing the flush control signal nay be performed firstly, and thereafter the step of generating and providing the electronic brake release signal to be received by the first electropneumatic valve may be performed. Thus, both the first electropneumatic valve and the second electropneumatic valve may be opened and remain open at the same time for a time period. This is the flushing stage. Thereafter, the second electropneumatic valve may be closed, causing the pressurized air provided via the first electropneumatic valve to build up a pressure in the control chamber and also in the spring brake chamber, releasing the brakes.

By firstly flushing the electropneumatic valves and then generate and provide the electronic brake release signal thereafter, consequences of unintentional locking of the brakes during the flushing are minimized or at least reduced.

Optionally, the method also may comprise the step of determining or predicting that an environmental temperature is, or will be, lower than a temperature threshold limit. The step of generating and providing the flush control signal may be performed after having determined or predicted that the environmental temperature is, or will be, lower than the temperature threshold limit.

When driving in hot climate, and/or in summertime, there is no risk of freezing. Flushing the electropneumatic valves is an advantage in cold climate/weather, but not necessarily when the temperature is, or is predicted to be warmer than 0 degrees. By not performing the provided solution in temperatures wherein freezing valves safely could be excluded, time is saved at the moment of starting the vehicle after having been parked.

According to yet an aspect of the invention, this objective is achieved by a computer program product comprising instructions which, when the program is executed by a computer, cause the computer to carry out the steps of the method according to the second aspect.

According to another aspect of the invention, this objective is achieved by a computer-readable storage medium comprising instructions which, when executed by a computer, cause the computer to carry out the steps of the method according to the second aspect.

According to another aspect of the invention, this objective is achieved by a vehicle comprising an electronically controlled pneumatic parking brake system according to the first aspect.

Thanks to the described aspects, a reliable yet easily implementable solution is provided for preventing build-up of ice formation in the electropneumatic valves. As the solution, at least according to some aspects, is not necessarily dependent on additional hardware, it could be implemented by a distributed software update. The operation of the electropneumatic valves does not affect functionality of the ordinary service brake, why the disclosed solution could be implemented with absent risks of affecting the functionality of the service brakes.

By preventing ice formation in the valves, continuous functionality of the parking brake is assured, also in sub-zero temperatures. Accidents and/or delays due to frozen parking brakes are thereby eliminated, or at least radically reduced.

Other advantages and additional novel features will become apparent from the subsequent detailed description.

### FIGURES

Embodiments of the invention will now be described in further detail with reference to the accompanying figures, in which:

FIG. 1 illustrates an embodiment of a vehicle, comprising an electronically controlled pneumatic parking brake system.

FIG. 2A illustrates a pneumatic parking brake arrangement for a vehicle, according to an embodiment, in a first state.

FIG. 2B illustrates a pneumatic parking brake arrangement for a vehicle, according to an embodiment, in a second state.

FIG. 2C illustrates a pneumatic parking brake arrangement for a vehicle, according to an embodiment, in a flush state.

FIG. 3A illustrates an electronically controlled pneumatic parking brake system in an embodiment wherein the parking brakes are implemented as disc brakes, in a first state.

FIG. 3B illustrates an electronically controlled pneumatic parking brake system in an embodiment wherein the parking brakes are implemented as disc brakes, in a second state.

FIG. 4 illustrates a method for a controller of a vehicle comprising an electronically controlled pneumatic parking brake system, in an embodiment.

### DETAILED DESCRIPTION

Embodiments of the invention described herein are defined as an electronically controlled pneumatic parking brake system and a method, which may be put into practice in the embodiments described below. These embodiments may, however, be exemplified and realized in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and proce-dures described herein. Like numbers refer to like elements throughout.

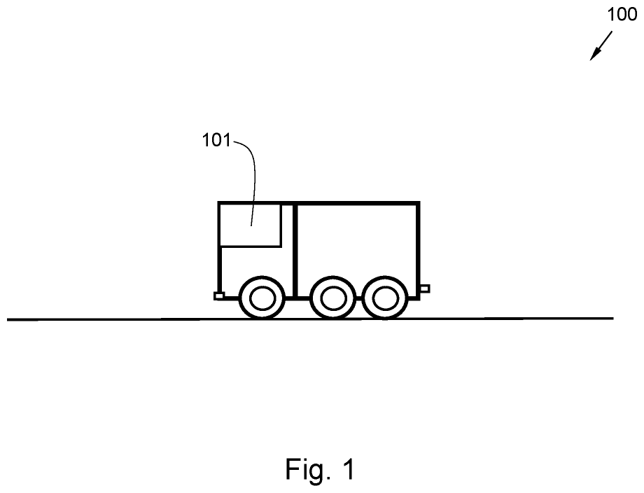

FIG. 1 illustrates a vehicle 100 comprising an electronically controlled pneumatic parking brake system.

The vehicle 100 could for example be or comprise a truck, a car, a trailer, a bus, an articulated vehicle (comprising a tractor and a trailer/semi-trailer) or other similar manned or unmanned (i.e., autonomously controlled) means of conveyance on a driving surface. However, for enhanced clarity, the vehicle 100 is subsequently described as having a driver.

The vehicle 100 may comprise a cabin 101, in which a driver normally is situated during operation of the vehicle 100. In some alternative embodiments, wherein the vehicle 100 may be driverless, i.e., autonomously controlled, the vehicle 100 may not comprise any cabin.

The vehicle 100 also comprises a propulsion unit such as an internal combustion engine, an electrical engine, or a combination thereof.

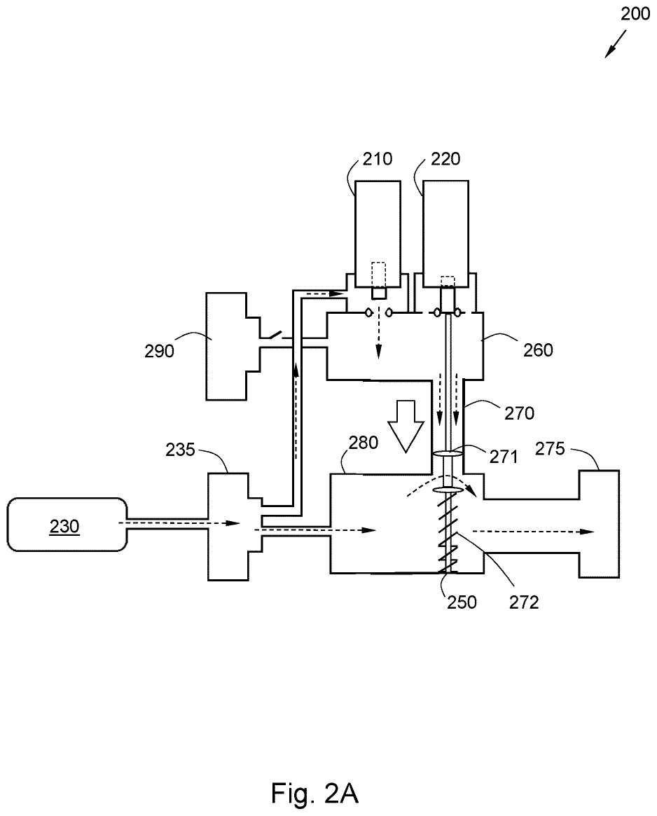

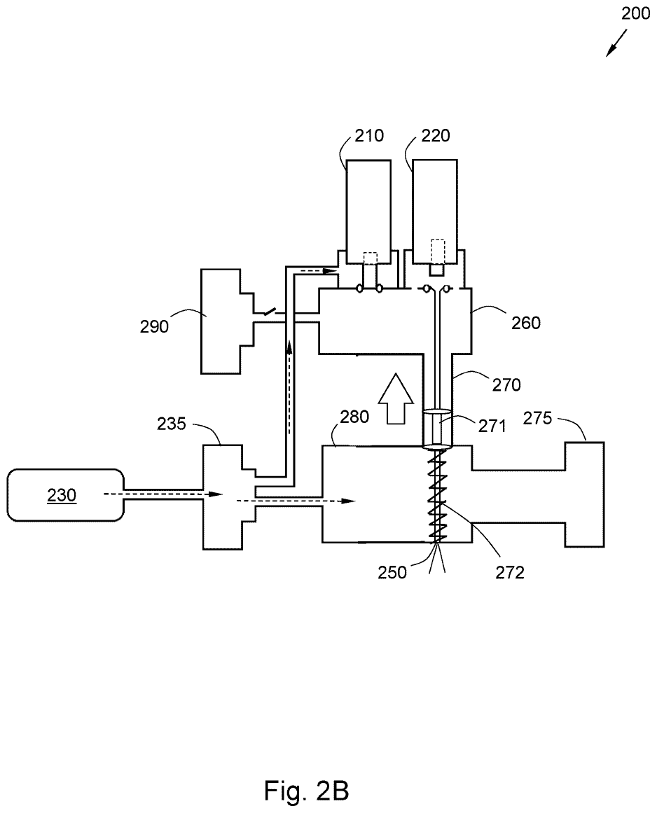

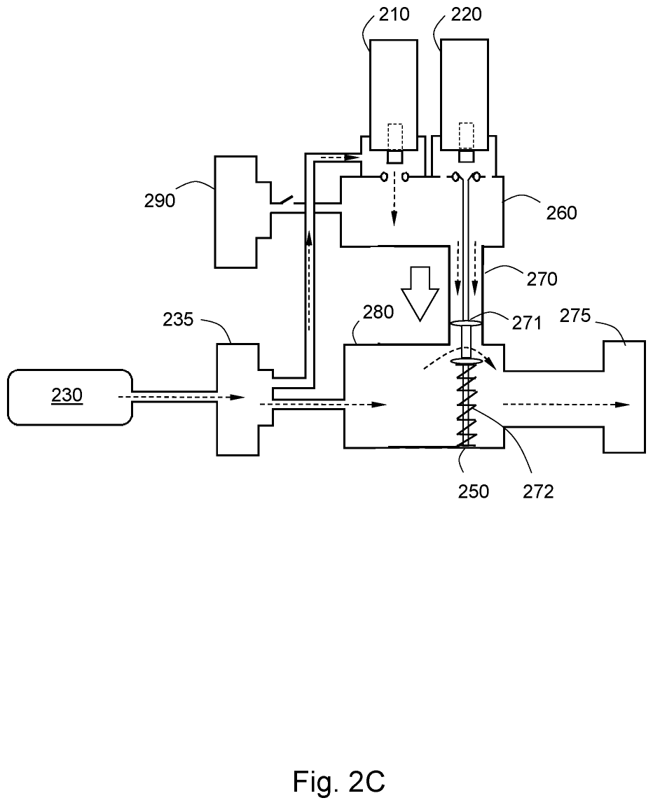

FIGS. 2A-2C schematically illustrate a pneumatic parking brake arrangement 200 of the vehicle 100 of FIG. 1.

The parking brake arrangement 200 is a mechanism to ascertain that the vehicle 100 is maintained motionless when parked, also when the vehicle 100 has been parked for example in a slope or other uneven underneath, where gravity or impact by another vehicle otherwise may bring the vehicle 100 into undesired movements, by immobilising wheels of the vehicle 100. The parking brake functionality is sometimes also referred to as a hand brake (to distinguish it from the mechanically independent service brake, or footbrake as it also may be referred to, which is commonly used during propulsion of the vehicle 100). The vehicle 100 may comprise additional service brakes, auxiliary brakes such as retarder, or similar system for decreasing vehicle speed during propulsion.

The pneumatic parking brake arrangement 200 may comprise various components, such as an air supply source connection 235, for providing compressed air.

The pneumatic parking brake arrangement 200 comprises brake chamber connection 275, connected to a spring brake chamber associated with a parking brake.

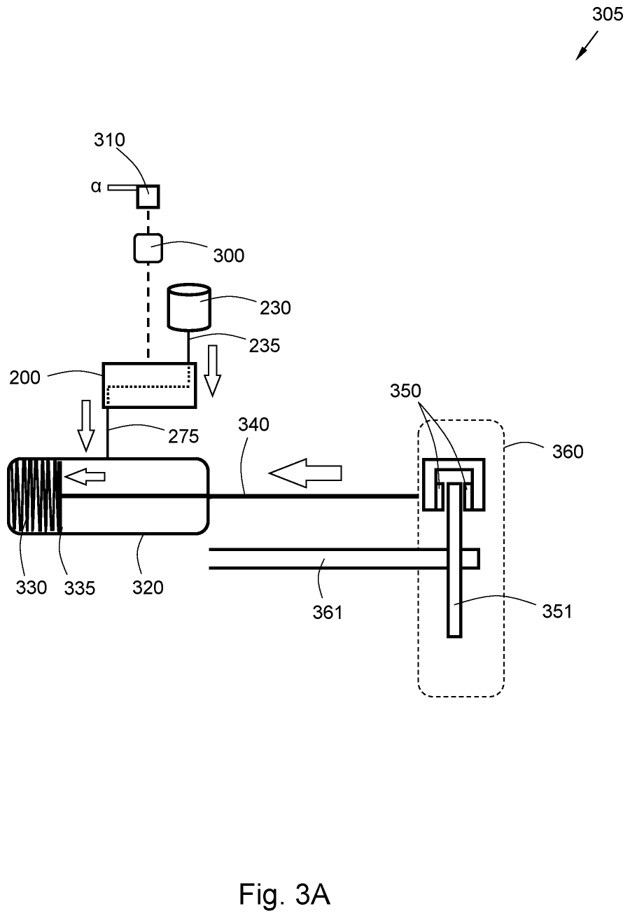

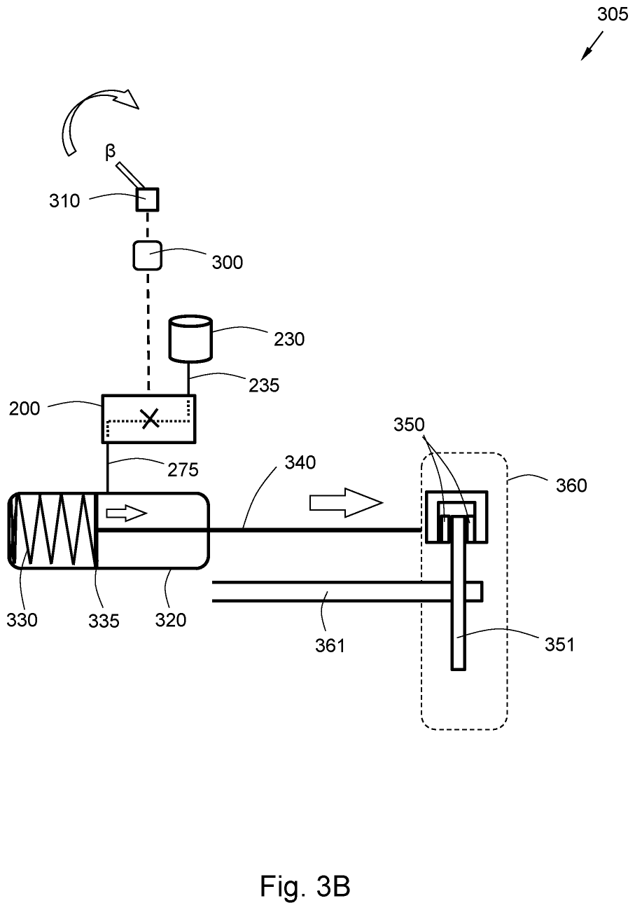

The parking brake is released when pressurized air is provided to the spring brake chamber, and applied when the pressurized air is evacuated from the spring brake chamber. The details of the functionalities of the parking brake and the spring brake chamber are illustrated and described more in detail in FIGS. 3A-3B and corresponding section of the description.

In a typical scenario, the vehicle 100 may comprise one parking brake per wheel set of the vehicle 100. However, in alternative embodiments only some or one wheel set of the vehicle 100 may comprise a parking brake.

In case the vehicle 100 comprises an articulated vehicle, brakes on all or at least some or one of the brakes of the trailer/semi-trailer may comprise a respective spring brake chamber.

In the subsequent description, a scenario with parking brake on a non-articulated vehicle 100 is described.

The supply of pressurized air to the spring brake chamber of the parking brake from the air supply source is controlled by a controller, via a first electropneumatic valve 210, and a second electropneumatic valve 220. The electropneumatic valves 210, 220 may comprise a solenoid or other similar means for setting the respective valve 210, 220 in positions for allowing/disallowing passage of pressurized air by opening/closing the respective electropneumatic valve 210, 220.

The controller may comprise e.g., one or several Electronic Control Units (ECUs), typically a plurality of interacting ECUs. The controller may comprise a digital computer that controls one or more electrical systems, or electrical sub systems, of the vehicle 100, based on e.g., information read from the sensors placed at various parts and in different components of the vehicle 100, and/or signals generated by the driver, or an autonomous driving system. The controller is configured to evaluate the obtained sensor detection readings/signals, e.g., compare it/them with a respective threshold limit and generate control signals, based on the outcome of the comparison.

Computer in the current context may be regarded as any hardware or hardware/ firmware device implemented using processing circuity such as, but not limited to, a processor, Central Processing Unit (CPU), a controller, an Arithmetic Logic Unit (ALU), a digital signal processor, a microcomputer, a Field Programmable Gate Array (FPGA), a System-on-Chip (SoC), a programmable logic unit, a microprocessor, an application-specific integrated circuit, or any other device capable of electronically performing operations in a defined manner.

The first electropneumatic valve 210 and the second electropneumatic valve 220 are both communicatively connected to the controller via a wired or wireless communication interface.

Various entities on-board the vehicle 100 may communicate and/or exchange information over a datalink, e.g., via a bus such as e.g., a Controller Area Network (CAN) bus, a Media Oriented Systems Transport (MOST) bus, or similar.

Communication may alternatively be made over a wireless communication interface, such as e.g., Vehicle-to-Vehicle (V2V) communication, or Vehicle-to-Infrastructure (V2I) communication. The common term Vehicle-to-Everything (V2X) is sometimes used. The wireless communication may then be based on Dedicated Short-Range Communications (DSRC) devices. DSRC works in 5.9 GHz band with bandwidth of 75 MHz.

The first electropneumatic valve 210 is connected to the air supply source 230 and to a control chamber 260. The first electropneumatic valve 210 is operable to release the parking brake by opening the valve 210, thereby allowing compressed air to flow through the first electropneumatic valve 210 into the control chamber 260 when receiving an electronic brake release signal from the controller.

The pressure that builds up in the control chamber 260 by the compressed air acts on a control piston 271 and overcomes the pressure of a spring 272 in a working chamber 270, such that pressurized air is allowed to flow via a supply chamber 280 and the brake chamber connection 275 to the brake chamber.

Thereby, the parking brake is released and the vehicle 100 is ready for take-off.

The pneumatic parking brake arrangement 200 may also comprise a control port 290, through which pressurized air may be supplied to the control chamber 260 in a case of emergency when ice is blocking the first electropneumatic valve 210, or the first electropneumatic valve 210 is not working for some other reason.

In the opposite case, when switching from driving to parking is desired, the second electropneumatic valve 220 is opened, when receiving a control signal from the controller.

The second electropneumatic valve 220 is connected to the control chamber 260 and to an exhaust port 250, through which pressurized air from the control chamber 260 is releasable to atmosphere. The second electropneumatic valve 220 is operable to activate the parking brake by opening the valve 220 thereby releasing the compressed air from the control chamber 260 to atmosphere via the second electropneumatic valve 220 when receiving the electronic brake apply signal from the controller, as illustrated in FIG. 2B. When the compressed air is released from the control chamber 260, the working chamber spring 270 closes the supply of compressed air from the supply chamber 280 to the outlet/spring chamber connection 275 and instead opens the spring brake chamber connection 275 to atmosphere, via the exhaust port 250.

Pressurized air in the spring brake chamber of the parking brake is thereby allowed to be released through the exhaust port 250 to atmosphere. When there is atmospheric pressure in the spring brake chamber, the parking brake will be applied.

The provided solution comprises flushing the first electropneumatic valve 210 and the second electropneumatic valve 220, in order to let compressed air flow from the air supply source 230, through both the electropneumatic valves 210, 220, for example when the vehicle 100 is stationary, and/or when the parking brake is to be released/deactivated, after having been activated during parking. This scenario is illustrated in FIG. 2C. The extension in time of the flushing may be selectable, predetermined, and/or be determined based on some criteria, such as the ambient temperature. For example, the extension in time could be selected or determined to be relatively shorter for a relatively higher ambient temperature. A suitable time could be one second, or there about, e.g., 0.5-1.5 seconds. Other time extensions are possible.

The purpose of the flushing of the electropneumatic valves 210, 220 is to evacuate any moisture and/or particles accumulated in the electropneumatic valves 210, 220 to atmosphere, thereby preventing ice formation in the valves 210, 220. Thereby, functionality of the parking brakes also in sub-zero temperatures is assured, or at least improved.

In some embodiments, the above-described flushing may be performed, for example, each time the parking brake is to be released/deactivated before take-off, i.e., before releasing the parking brake. For example, a flush could be initiated automatically each time a parking brake release command is given, e.g., by a driver. The vehicle is stationary when such a command is given. In other embodiments, the flushing may be performed at any occasion when the vehicle 100 is determined to be stationary, and/or at regular time intervals. For example, a flush could be initiated automatically when the vehicle 100 is determined to be stationary and a predefined time has passed since the latest flush.

In yet some embodiments, the flushing of the electropneumatic valves 210, 220 may be made when an environmental temperature is, or is predicted to be, lower than a temperature threshold limit, such as for example about 0 degrees Celsius, or a bit above for having a margin, for example at 0 -10 degrees. Thereby, any moisture or particles accumulated in the valves 210, 220 can be evacuated via the exhaust port 250 before the temperature falls below a freezing point and turns the moisture into ice.

The vehicle 100 may comprise a temperature sensor, for example dedicated for determining an environmental temperature. The temperature sensor may be communicatively connected to the controller.

Alternatively, information on an ambient temperature may be obtained from a vehicle external source, for example a temperature sensor or weather service situated at the roadside or in another location. Such information could be obtained by the vehicle via a wireless communication interface.

The temperature may alternatively or in addition be estimated based on a combination of knowledge of geographical position of the vehicle 100, planned driving route/destination/driving direction of the vehicle 100, and knowledge of date/time and statistical data related to expected temperatures related to the date/time at the (current or future) geographical position of the vehicle 100.

In yet some embodiments, knowledge of date/time in combination with current or future geographical position of the vehicle 100 and meteorological forecast data relevant for the geographical position in combination with date/time may be relied upon.

Image recognition is another option. A sensor in form of a camera may in conjunction with an image recognition program detect snow and/or ice in the environment or condense in the exhale air of humans situated outside, for example; or detect whether humans are wearing wintertime garments.

In yet some alternative embodiments, the length of the flush may be adjusted based on the estimated/predicted temperature, wherein a colder temperature renders a longer time for flushing, and vice versa.

FIGS. 3A-3B schematically illustrate an electronically controlled pneumatic parking brake system 305, comprising various components interacting with the pneumatic parking brake arrangement 200, such as for example a hand control unit 310, a spring brake chamber 320, and a parking brake 360 comprising friction pads 350 in a caliper, operative to act on a disc 351, which is fixedly mounted on a wheel axle 361.

The vehicle 100 may have the same type of brakes on all axles/wheels, for example disc brakes on all axles/wheels; or alternatively drum brakes on all axles/wheels.

The vehicle 100 may have one type of brakes on the front axle/wheels and another type of brakes on rear axles/s wheels; for example, disc brakes on the front axle/wheels while drum brakes may be applied on rear axles/s wheels.

In the schematic illustration in FIG. 3A-B, the parking brake 360 is represented by a disc brake.

The electronically controlled pneumatic parking brake system 305 may comprise a hand control unit 310, in some embodiments wherein the vehicle 100 is driven by a human driver. The hand control unit 310 may be physically situated in the cabin 101 of the vehicle 100 at some appropriate position where the driver is able to reach it without excessive ergonomical inconvenience, preferably while seated in the driving seat. In case of using the electronically controlled pneumatic parking brake system 305 as an emergency brake in an emergency situation, it may be important to enable the driver to easily find and pull/operate the hand control unit 310.

The hand control unit 310 may comprise a hand lever which may be positioned/set in an inactive position a while driving the vehicle 100, i.e., the parking brake is released allowing the wheels of the vehicle 100 to roll. This is illustrated in FIG. 3A.

The hand control unit 310 may alternatively be set in an active position @ when it is desired to park the vehicle 100. The parking brake 360 of the vehicle 100 is activated, immobilising vehicle wheels.

FIG. 3A illustrates a situation wherein the vehicle 100 is driving, and the parking brake 360 is released. In case the vehicle 100 comprises a driver and a hand control unit 310, the hand control unit 310 is then set in the inactive position a.

An electronic brake release signal may then be provided to the controller 300. The controller 300 may in turn generate a control signal to be provided to the first electropneumatic valve 210, for opening the valve 210.

The first electropneumatic valve 210 is then at least temporarily opened, thereby allowing compressed air of the air supply source 230, provided via an air supply source connection 235 and the outlet/spring chamber connection 275 to the spring brake chamber 320.

Pressurized air is allowed to enter/fill the spring brake chamber 320, which is exercising a pressure on a spring 330 via an airtight seal/diaphragm 335 in the spring brake chamber 320. The pressurized air in the spring brake chamber 320 is thereby overcoming the spring force of the spring 330, as long as pressurized air is maintained in/provided to the spring brake chamber 320.

A physical connection linkage 340 between the spring 330 and at least one of the friction pads 350 is thereby pulled away from the disc 351, disengaging the brake 360, thereby allowing the wheel/wheel axle 361 to rotate freely without obstruction.

FIG. 3B illustrates the electronically controlled pneumatic parking brake system 305 comprising the same components as previously illustrated in FIG. 3A. However, in this scenario, the parking brake 360 is engaged.

Thus, the hand control unit 310 is set into the active position. The passage of pressurized air from the pressurized air supply source 230 is discontinued, as the second electropneumatic valve 220 is at least temporarily opened which allows the pressurized air maintained in the spring brake chamber 320 to be evacuated to atmosphere.

When no pressurized air is maintained in the spring brake chamber 320, the spring force of the spring 330 is causing a pressing action on the friction pads 350 towards the disc 351 of the disc brake 360 thereby disallowing rotational movement of the wheel/axle 261.

Thereby, thanks to the functionality of the spring brake chamber/s 320, the parking brake 360 automatically becomes activated and engaged when there is an air supply leakage or other anomaly in the air pressure, and/or when the pressurized air supply source 230 has run out of pressurized air. A compressor may then be activated to refill the pressurized air supply source 230 with pressurized air, before the parking brakes 360 could be released.

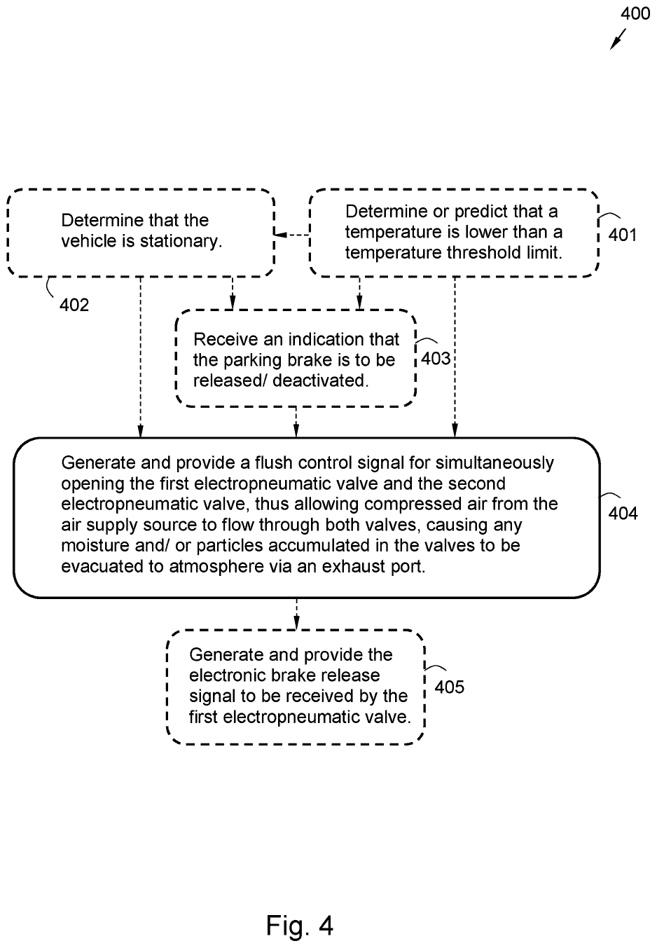

FIG. 4 illustrates an example of a method 400 according to an embodiment. The flow chart in FIG. 4 shows the method 400 for a controller of a vehicle 100 comprising an electronically controlled pneumatic parking brake system 305. The purpose of the method 400 is to flush the first and second electropneumatic valves 210, 220 of the system 305, thereby preventing ice formation in the valves 210, 220.

In order to be able to correctly flush the valves 210, 220, the method 400 may comprise a number of steps 401-405. However, some of these steps 401-405 may be performed in various alternative manners. Some method steps may only be performed in some optional embodiments; such as e.g., steps 401-403 and/or 405. Further, the described steps 401-405 may be performed in a somewhat different chronological order than the numbering suggests. The method 400 may comprise the subsequent steps:

Step 401, which may be performed in some embodiments, comprises determining, or predicting, that an environmental temperature is lower than a temperature threshold limit.

The environmental temperature may be detected e.g., by an onboard temperature sensor, dedicated for determining an ambient temperature.

Alternatively, information on an ambient temperature may be obtained from a vehicle external source, for example a temperature sensor or weather service situated at the roadside or in another location, or in another vehicle for example. Such information could be obtained by the vehicle 100 via a wireless communication interface.

The temperature may be determined based on meteorological data and positioning of the vehicle 100, and/or in combination with driving direction of the vehicle 100. Alternatively, temperature may be just estimated based on statistical data concerning temperature and date on the geographical position of the vehicle 100. Image recognition is another option. A sensor in form of a camera may in conjunction with an image recognition program detect snow and/or ice in the environment or condense in the exhale air of humans situated outside, for example.

The temperature threshold limit may be set to around 0 -10 degrees Celsius. Other temperature thresholds are possible.

Another possibility may be to assume that the ambient temperature, and thus the temperature of the valves 210, 220, is lower than a temperature threshold limit when the driver has activated the cabin heater/seat heating, or defroster. That is, the flush can be controlled to be performed when a driver has activated some vehicle function to keep him or her warm.

Step 402, which may be performed in some embodiments, comprises determining that the vehicle 100 is stationary.

Stationary state of the vehicle 100 may be determined based on usage of a combination of sensors, software, and communication systems, for example based on an Inertial Measurement Unit (IMU) on-board the vehicle 100. The IMU is enabled to measures linear and angular velocity. If no detection of any change in vehicle position is made within a predetermined time period, it may be concluded that the vehicle 100 is stationary.

A satellite based navigator of the vehicle 100, for example Global Positioning System (GPS) or other Global Navigation Satellite Systems (GNSS) that provides geolocation and time information to a receiver in the vehicle 100. While GPS is not always accurate to the centimetre, it may be used for determining if the vehicle 100 has not changed its global position for a period of time.

Another option is to use wheel speed sensors of the vehicle 100. The wheel speed sensors are configured to measure the rotation speed of each wheel of the vehicle 100. In case the wheel speed is zero on all wheels, it may be assumed that the vehicle 100 is stationary.

The decision may also, or alternatively be based on visual sensors on-board. By using a camera and machine vision algorithms, environmental visual data may be analysed. In case everything in the field of view remains static within a time period, then the vehicle 100 could be assumed to not be moving. Lidar and/or radar sensors on-board may be used in the same way.

Communication with sensors in environmental infrastructures such as traffic lights, road sensors (via V2I), or other vehicles (via V2V) may also or alternatively be used for determining stationary state of the own vehicle 100.

The vehicle 100 may also, or alternatively be determined to be stationary in case the driver (if any) applies the parking brake 360 via the hand control unit 310 in the cabin 101.

Step 403, which may be performed in some embodiments, comprises receiving an indication that the parking brake 360 is to be released/deactivated.

In case the vehicle 100 has a human driver in the cabin 101, it may be assumed that the parking brake 360 is to be released/deactivated when the hand control unit 310 is set in released position a.

In an autonomous vehicle without driver, the indication that the parking brake 360 is to be released/deactivated may be based on sensor data, in combination with a driving schedule, for example. Environmental sensors such as cameras, lidar, radar, ultrasonic sensors, etc., may scan the vehicle's surroundings and provide data. When it is determined that no obstacle is in the way, and the driving schedule of the vehicle 100 indicates that it is time to go to keep the time schedule, it may be determined to release the parking brake 360.

Step 404 comprises generating and providing a flush control signal for opening both the first electropneumatic valve 210 and the second electropneumatic valve 220. These two electropneumatic valves 210, 220 may be opened, and remain open at the same time for at least some moment. Compressed air is thereby allowed to flow through both valves 210, 220 causing any moisture and/or particles, such as for example water/ice particles, accumulated in the electropneumatic valves 210, 220 to be evacuated to atmosphere via an exhaust port 250.

By flushing the first and second electropneumatic valves 210, 220 of the system 305, ice formation in the valves due to humidity in the compressed air, is prevented in sub-zero degrees temperatures.

In some embodiments, the step of generating and providing 404 the flush control signal may be performed only after having determined 401 that the environmental temperature is or is predicted to be lower than the temperature threshold limit.

In some embodiments, the step of generating and providing 404 the flush control signal may be performed only after having determined 402 that the vehicle 100 is stationary.

In yet some embodiments, the step of generating and providing 404 the flush control signal may be performed only when having received 403 the indication that the parking brake 360 is to be released/deactivated.

Step 405, which only may be performed in some embodiments wherein step 404 firstly has been performed, comprises generating and providing the electronic brake release signal to be received by the first electropneumatic valve 210.

The above described method steps 401-405 to be performed in the vehicle 100 may be implemented through the one or more controllers 300, together with a computer program product for performing at least some of the functions of the method steps 401-405. Thus, a computer program product, comprising instructions for performing the method steps 401-405 in the controller may perform the method 400 for generating and providing a flush control signal for simultaneously opening the first electropneumatic valve 210 and the second electropneumatic valve 220, thus allowing compressed air from the air supply source 230 to flow through both electropneumatic valves 210, 220, causing any moisture and/or particles accumulated in the electropneumatic valves 210, 220 to be evacuated to atmosphere via the exhaust port 250, when the computer program is loaded into the controller 300.

The computer program product mentioned above may be provided for instance in the form of a computer readable medium or data carrier carrying computer program code for performing at least some of the method steps 401-405 when being loaded into the controller 300. The computer-readable medium may be a non-transitory computer-readable medium, such as a tangible electronic, magnetic, optical, infrared, electromagnetic, and/or semiconductor system, apparatus, and/or device.

The terminology used in the description of the embodiments as illustrated in the accompanying drawings is not intended to be limiting of the described electronically controlled pneumatic parking brake system 305, method 400, computer program product, computer-readable storage medium and/or vehicle 100. Different features illustrated in different FIGS. 1-4 and/or described in different sections of the description may with certain advantage be combined with each other, in different embodiments.

Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g., a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware but may also be distributed in other forms such as via Internet or other wired or wireless communication system.

1. An electronically controlled pneumatic parking brake system for a vehicle, wherein the system comprises:
a controller configured to generate an electronic brake apply signal when receiving an indication of that a parking brake is to be onset/activated, and to generate an electronic brake release signal when receiving an indication of that the parking brake is to be released/deactivated;
an air supply source, for providing compressed air;
a first electropneumatic valve, communicatively connected to the controller and connected to the air supply source and to a control chamber, wherein the first electropneumatic valve is operable to release the parking brake by opening the valve, thereby allowing compressed air to flow through the first electropneumatic valve into the control chamber when receiving the electronic brake release signal from the controller; and
a second electropneumatic valve, communicatively connected to the controller and connected to the control chamber and to an exhaust port, wherein the second electropneumatic valve is operable to activate the parking brake by opening the valve thereby releasing the compressed air from the control chamber to atmosphere via the second electropneumatic valve when receiving the electronic brake apply signal from the controller,
wherein the controller is configured to generate and provide a flush control signal for simultaneously opening the first electropneumatic valve and the second electropneumatic valve, thus allowing compressed air from the air supply source to flow through both the electropneumatic valves, causing any moisture and/or particles accumulated in the electropneumatic valves to be evacuated to atmosphere via the exhaust port.

2. The system according to claim 1, wherein the controller is configured to generate and provide the flush control signal, when the vehicle is stationary.

3. The system according to claim , wherein the controller is configured to generate and provide the flush control signal when receiving an indication of that the parking brake is to be released/deactivated.

4. The system according to claim 3, wherein the controller is configured to, when receiving the indication of that the parking brake is to be released/deactivated, firstly generate and provide the flush control signal, and thereafter generate and provide the electronic brake release signal.

5. The system according to claim 1, wherein the controller is configured to generate and provide the flush control signal when an environmental temperature is, or is predicted to be, lower than a temperature threshold limit.

6. A method for control of a vehicle comprising an electronically controlled pneumatic parking brake system, wherein the pneumatic parking brake system comprises:
a controller configured to generate an electronic brake apply signal when receiving an indication of that a parking brake is to be onset/activated, and to generate an electronic brake release signal when receiving an indication of that the parking brake is to be released/deactivated;
an air supply source, for providing compressed air;
a first electropneumatic valve, communicatively connected to the controller and connected to the air supply source and to a control chamber, wherein the first electropneumatic valve is operable to release the parking brake by opening the valve, thereby allowing compressed air to flow through the first electropneumatic valve into the control chamber when receiving the electronic brake release signal from the controller; and
a second electropneumatic valve, communicatively connected to the controller and connected to the control chamber and to an exhaust port, wherein the second electropneumatic valve is operable to activate the parking brake by opening the valve thereby releasing the compressed air from the control chamber to atmosphere via the second electropneumatic valve when receiving the electronic brake apply signal from the controller,
wherein the method, operated by the controller, comprises the step of:
generating and providing a flush control signal for simultaneously opening the first electropneumatic valve and the second electropneumatic valve, thus allowing compressed air from the air supply source to flow through both electropneumatic valves, causing any moisture and/or particles accumulated in the electropneumatic valves to be evacuated to atmosphere via an exhaust port.

7. The method according to claim 6, comprising the step of:
determining that the vehicle is stationary, and
wherein the flush control signal is generated and provided when having determined that the vehicle is stationary.

8. The method according to claim 6, comprising the step of:
receiving an indication that the parking brake is to be released/deactivated, and
wherein the flush control signal is generated and provided when having received the indication that the parking brake is to be released/deactivated.

9. The method according to claim 8, wherein the step of generating and providing the flush control signal is performed firstly, and thereafter performing the step of:
generating and providing the electronic brake release signal to be received by the first electropneumatic valve.

10. The method according to claim 6, wherein the method also comprises the step of:
determining or predicting that an environmental temperature is, or will be, lower than a temperature threshold limit; and wherein the step of generating and providing the flush control signal is performed after having determined or predicted that the environmental temperature is, or will be, lower than the temperature threshold limit.

11. A computer program product stored on a non-transitory computer-readable medium, said computer program product for controlling a vehicle comprising an electronically controlled pneumatic parking brake system, wherein the pneumatic parking brake system comprises:
a controller configured to generate an electronic brake apply signal when receiving an indication of that a parking brake is to be onset/activated, and to generate an electronic brake release signal when receiving an indication of that the parking brake is to be released/deactivated;
an air supply source, for providing compressed air;
a first electropneumatic valve, communicatively connected to the controller and connected to the air supply source and to a control chamber, wherein the first electropneumatic valve is operable to release the parking brake by opening the valve, thereby allowing compressed air to flow through the first electropneumatic valve into the control chamber when receiving the electronic brake release signal from the controller;
a second electropneumatic valve, communicatively connected to the controller and connected to the control chamber and to an exhaust port, wherein the second electropneumatic valve is operable to activate the parking brake by opening the valve thereby releasing the compressed air from the control chamber to atmosphere via the second electropneumatic valve when receiving the electronic brake apply signal from the controller,
wherein said computer program product comprising computer instructions to cause the controller to perform the following operation:
generate and provide a flush control signal for simultaneously opening the first electropneumatic valve and the second electropneumatic valve, thus allowing compressed air from the air supply source to flow through both electropneumatic valves, causing any moisture and/or particles accumulated in the electropneumatic valves to be evacuated to atmosphere via an exhaust port.

12. (canceled)

13. A vehicle comprising an electronically controlled pneumatic parking brake system, said pneumatic parking brake system comprising:
a controller configured to generate an electronic brake apply signal when receiving an indication of that a parking brake is to be onset/activated, and to generate an electronic brake release signal when receiving an indication of that the parking brake is to be released/deactivated;
an air supply source, for providing compressed air;
a first electropneumatic valve, communicatively connected to the controller and connected to the air supply source and to a control chamber, wherein the first electropneumatic valve is operable to release the parking brake by opening the valve, thereby allowing compressed air to flow through the first electropneumatic valve into the control chamber when receiving the electronic brake release signal from the controller; and
a second electropneumatic valve, communicatively connected to the controller and connected to the control chamber and to an exhaust port, wherein the second electropneumatic valve is operable to activate the parking brake by opening the valve thereby releasing the compressed air from the control chamber to atmosphere via the second electropneumatic valve when receiving the electronic brake apply signal from the controller,
wherein the controller is configured to generate and provide a flush control signal for simultaneously opening the first electropneumatic valve and the second electropneumatic valve, thus allowing compressed air from the air supply source to flow through both the electropneumatic valves, causing any moisture and/or particles accumulated in the electropneumatic valves to be evacuated to atmosphere via the exhaust po
